(19) United States
(12) Patent Application Publication
(10) Pub. No.: US 2007/0230419 A1
(43) Pub. Date: Oct. 4, 2007

(54) QoS signaling to support fairness

(76) Inventors: Sundar Raman, Westford, MA (US); Vivek Sharma, Chelmsford, MA (US)

Correspondence Address: FISH & RICHARDSON PC, P.O. BOX 1022, MINNEAPOLIS, MN, 55440-1022, US

(21) Appl. No.: 11/396,347

(22) Filed: Mar. 31, 2006

(51) Int. Cl. H04Q 7/24

(52) U.S. Cl. 370/338

(57) ABSTRACT

A radio network controller allocates a share of network resources to an access terminal that may be used by more than one user. The share is based on a parameter received from the access terminal and that identifies a number of users using the access terminal.

### TECHNICAL FIELD

This description relates to QoS signaling to support fairness.

### BACKGROUND

Cellular wireless communications systems are designed to serve many access terminals distributed in a large geographic area by dividing the area into cells. At the center of each cell, a radio node is located to serve access terminals (e.g., cellular telephones, laptops, PDAs) located in the cell. In some cases access terminals may route traffic from additional sources, for example a single access terminal on board an aircraft may relay data from other on-board devices to a radio node on the ground. In each cell, a radio node communicates with multiple access terminals, allowing the access terminals to communicate with a radio access network of which the radio node is a part. Additional network layers ultimately link the access terminal, through the radio access network, to the Internet or another data network. Each layer can support a certain amount of traffic, and this amount is shared among all the devices using that layer. It is often desirable to regulate the amount of network bandwidth that can be used by any one access terminal, to assure a fair distribution of resources.

### SUMMARY

In general, in one aspect, a radio network controller allocates a share of network resources to an access terminal that may be used by more than one user. The share is based on a parameter received from the access terminal and that identifies a number of users using the access terminal.

Implementations include one or more of the following features. The parameter identifies a range. The parameter includes a pre-defined value of a configuration parameter of a communication protocol. The communication protocol includes an Ev-DO protocol and the configuration parameter includes the ProfilelD. Allocating a share of network resources includes determining a Grade of Service (GoS) appropriate to the number of users of the access terminal. Communicating information describing the allocated share of network resources to a radio node in communication with the access terminal. Updating the share of network resources based on a new value of the parameter received from the access terminal. Allocating a share of network resources includes determining an amount of data that should be transmitted from the access terminal in a reverse link, based on the number of users of the access terminal, and communicating an attribute representing the determined amount of data to the access terminal. The parameter includes a pre-defined value of a configuration parameter of an Ev-DO protocol, the configuration parameter includes one or more of BucketLevelMaxNN, T2lnFlowRangeNN, and T2TransitionFunctionNN, and in which communicating the attribute to the access terminal includes using Generic Attribute Update Protocol (GAUP) to reconfigure the access terminal's reverse traffic channel media access controller (RTCMAC). Allocating other shares of network resources to other access terminals based on values of the parameter received from the other access terminals.

In general, in one aspect, a radio network controller allocates shares of network resources between access terminals based on a parameter received from each of the access terminals identifying a number of users using each of the access terminals.

Implementations include one or more of the following features. Allocating shares of network resources includes allocating a share of network resources to each access terminal based on the number of users of that access terminal as compared to the number of users of all the access terminals. Allocating shares of network resources includes allocating a share of network resources to each access terminal based on a targeted quality of service to each user.

In general, in one aspect, an access terminal establishes communication with a first user, transmits a parameter to a radio area network, and establishes communication with an additional user, transmits a second parameter to the radio area network.

In general, in one aspect, a system includes a radio network controller, a radio node, and a plurality of access terminals in communication with the radio node and the radio network controller. Each access terminal is configured to communicate to the radio network controller a parameter identifying a number of users of the access terminal. The radio network controller is configured to allocate shares of network resources among the access terminals based on the number of users of the access terminals, and to communicate information describing the allocation to the radio node.

Advantages of particular implementations include the ability to allocate bandwidth and other resources fairly and in a way that maintains targeted QoS without requiring detailed monitoring of communications and other costly measures.

Other features and advantages of the invention will be apparent from the description and the claims.

### DESCRIPTION OF DRAWINGS

FIG. 1 and 2 are block diagrams of a radio access network.

FIG. 3 is a flow chart.

### DETAILED DESCRIPTION

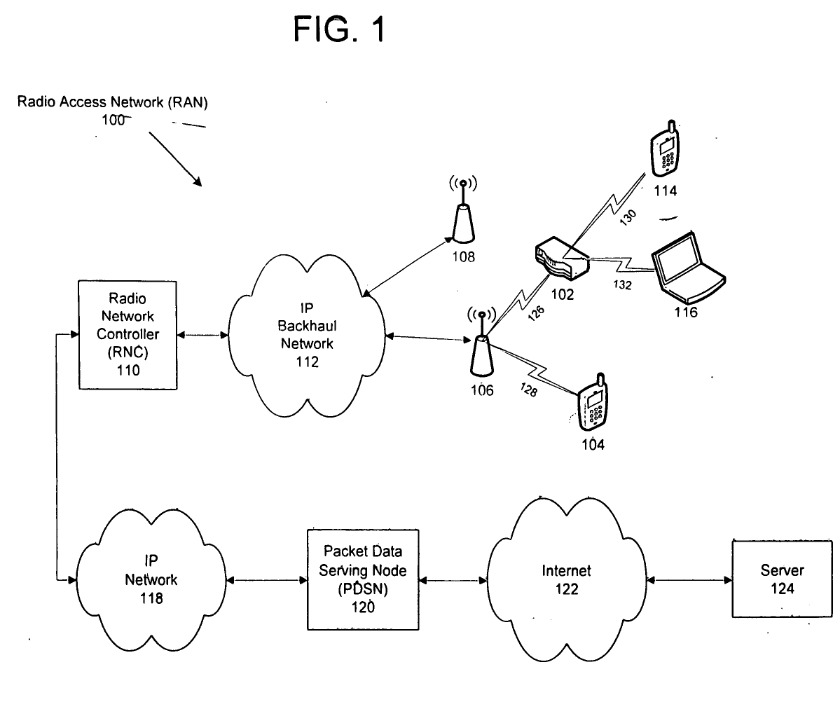

Referring to FIG. 1, a radio access network (RAN) 100 uses the CDMA2000 Evolution Data-Optimized (1x Ev-DO) protocol to transmit data packets between an access terminal (AT). e.g., access terminal 102 and 104, and an external network such as the Internet 122. The 1xEV-DO protocol has been standardized by the Telecommunication Industry Association (TIA) as TIA/EIA/IS-856, “CDMA2000 High Rate Packet Data Air Interface Specification,” 3GPP2 C.S0024-0, Version 4.0, Oct. 25, 2002, which is incorporated herein by reference. Revision A to this specification has been published as TIA/EIA/IS-856A, “CDMA2000 High Rate Packet Data Air Interface Specification,” 3GPP2 C.S0024-A, Version 2.0. July 2005. Revision A is also incorporated herein by reference.

The radio access network (RAN) 100, which may cover a large service area, includes a Radio Network Controller (RNC) 110, communicating with several radio nodes (RN) 106, 108, using a private or public IP backhaul network 112. The access terminals 102 and 104 may be single-user devices, such as a cellular telephone or PDA, or they may be multiple-user devices that allow user devices, e.g., PDA 114 and laptop 116, connected to the access terminal through local links 130, 132, to access the external network through the access terminal's data connection. Local links 130, 132 could be wired connections, e.g., Ethernet on a wired LAN, or wireless, e.g., Wi-Fi connections to a wireless LAN.

The radio network controller 110 is connected over a public or private IP network 118 to one or more Packet Data Serving Nodes (PDSNs) 120. The PDSN 120, in turn, receives and transmits data packets (e.g., voice over IP, web pages, images, email) to a server 124 via the Internet 122. In some implementations, the functions of an RN and an RNC are combined into a single device, also in some implementations the functions of a PDSN and an RNC are combined into a single device. In addition, in some implementations, functions of an RN, RNC, and PDSN are combined into a single device. The ideas in this disclosure are independent of the above combinations and the benefits apply equally. References in this description to a radio access network (RAN) taking action or being acted upon generally refer to an RNC or an RNC in combination with other devices.

Each access terminal, e.g., access terminal 102, 104, is in communication with a radio node, e.g., radio node 106, 108, via an air link, e.g., 126, 128. An air link comprises a forward link (also referred to as a downlink), which carries data transmitted from a radio node to an access terminal, and a reverse link (also referred to as an uplink), which carries data transmitted from the access terminal to the radio node.

In some examples, the RAN is not aware of whether an access terminal is a single-user or multiple-user device, or of how many users are currently using a given multiple-user device. In addition, some single-user devices may be converted into multiple-user devices, for example by coupling a 1xEv-DO access card to a wired or wireless local area network through an appropriately-equipped portable computer. In such a situation, the RAN may attempt to allocate network resources equally among all access terminals, which it perceives to be a “fair” allocation. As a result, the data throughput performance experienced by any single user of a multiple-user access terminal, for example, the user of the laptop 116 connected to the network through the access terminal 102, will be worse than the throughput performance experienced by a user of a single-user device such as the access terminal 104. Assuming that the network operator wants users, and not necessarily access terminals, to experience similar throughput performance, the RAN needs to apportion resources differently in such a situation.

In previous systems, RANs might have been configured to evaluate every packet of data received from each access terminal and determine the number of unique source device addresses (e.g., IP addresses) in the user data packet. The number of unique addresses from an access terminal is a direct measure of the number of unique users serviced by the access terminal. It may be advantageous however, to avoid such thorough inspection of every data packet, to decrease CPU processing overhead in the RAN and to increase data throughput through the RAN.

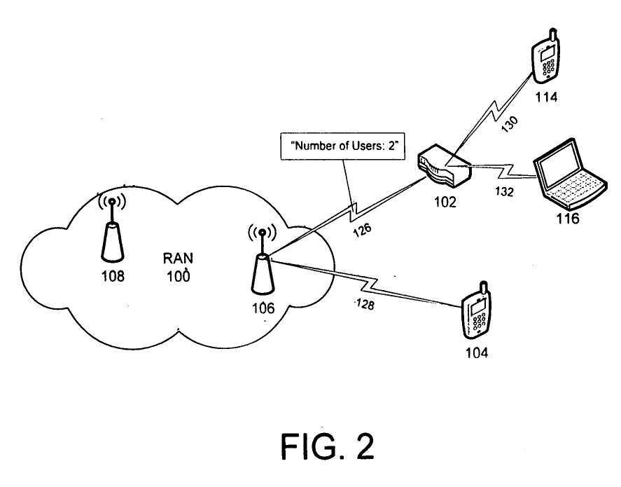

As shown in FIG. 2, another solution is for the access terminal 102 to keep track of the number of user devices 114, 116, it is servicing. The access terminal 102 conveys this information to the RAN 100, which uses it to adjust the allocation of network resources to provide the appropriate quality of service to each access terminal.

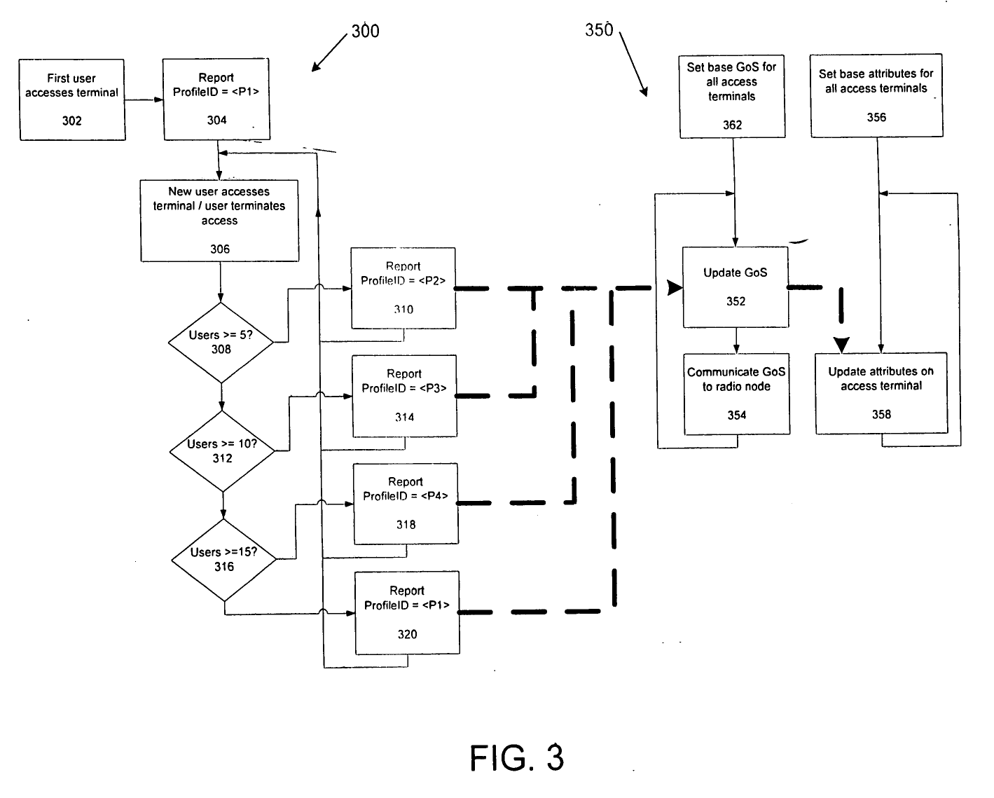

The 1xEv-DO protocols includes messages communicated between access terminals, and the RAN to report their status, make requests, adjust configurations, etc. One such protocol, the Multi Flow Packet Application (MFPA) protocol, defines a “ReservationKKQoSRequestFwd/Rev” attribute, which includes a ProfileValue field. The access terminal uses a ProfilelD (a hexadecimal number) in the ProfileValue field to signal to the RAN the application details. As an example, for the Video Telephony application, the ProfilelD indicates whether the access terminal wants to use video at 32 kbps or 64 kbps. The RAN allocates RAN resources based on the ProfileD. To use this feature to communicate the number of users to the RAN, the access terminal initially reports a ProfilelD that indicates that it is only servicing one user, for example, it transmits “ProfilelD=<P1>.” As shown in FIG. 3, the access terminal follows a procedure 300, which begins when the first user accesses the access terminal (302). The access terminal reports its ProfilelD to the RAN as <P1> (304). The access terminal then waits for additional users to start using the access terminal or for a current user to terminate access (306). Each time the number of users crosses some predefined threshold, e.g., a multiple of five users, the access terminal sends an updated ProfilelD. For example, when a fifth user begins using the access terminal (308) the access terminal reports an updated ProfilelD of <P2> and sends this to the RAN in an updated “ReservationKKQoSRequestFwd/Rev” attribute (310). Similarly, if the number of users goes above 10 and 15 (312, 316), the access terminal sends appropriately updated ProfileDs to the RAN (314, 318). If the number of users drops below 5, the ProfilelD is returned to <P1 > (320). In the example in FIG. 3, four ProfilelDs are shown, with any number of users over 15 resulting in ProfilelD <P4>. More or fewer thresholds could be used, within whatever limits the network operator wishes to set for the RAN.

The possible ProfilelD values are configurable at the RNC, and could be standardized or proprietary. For example, a group of network operators could agree upon a set of ProfilelDs so that an access terminal from any participating network operator could access an RAN operated by one of the others, and successfully tell that RAN that it was supporting more than one user. Conversely, a network operator could use a proprietary set of ProfilelDs, so that foreign access terminals would be unable to request a greater share of resources than any single-user device.

The Radio Node includes a Forward Link scheduler. The Forward Link scheduler is responsible for allocating the necessary bandwidth for each access terminal. One of the Forward Link scheduler attributes that controls the bandwidth of an access terminal is called “Grade of Service (GoS)” (this is the weight factor for each access terminal in the 1xEV-DO system. Other air interfaces would have a similar weight factor that may go by a different name). In the example of FIG. 3, the RAN employs a process 350. In the beginning, the RAN configures the same GoS for all access terminals (362). When the RAN receives an updated ProfilelD from an access terminal (indicating the number of end users using that access terminal), it reconfigures the GoS accordingly (352). When the number of end users for an access terminal crosses (either goes up or down) a threshold value, the GoS is adjusted (goes up or down). The GoS determines the share of network bandwidth that is allocated to an access terminal on the forward link. The RAN conveys this new GoS to the radio node servicing the access terminal to be used in scheduling forward-link resources (354). That is, an access terminal servicing more users will receive a larger share of the available forward-link bandwidth than one servicing fewer users. Such resource allocation is generally only necessary on the air link between the radio node and the access terminal. On the network side of the radio node, e.g., within IP backhaul network 112 and IP network 118, and at the PDSN 120. individual users' packets are treated equally, and the networks are unaware whether the users are all using the same access terminal.

For the reverse link, the RAN uses the Generic Attribute Update Protocol (GAUP) to reconfigure the access terminal's reverse traffic channel media access controller (RTCMAC) parameters. RTMAC has various sub-types. In some examples, sub-type 3 (ST3) is used. For the 1x-EV-DO systems, three of the RTCMAC attributes are called BucketLevelMaxNN, T2lnFlowRangeNN, and T2TransitionFunctionNN. These attributes control the amount of data transmitted from the access terminal in the Reverse Link. These attributes can be changed by the RAN for each access terminal. To start with, the RAN configures the same values of BucketLevelMaxNN, T2lnFlowRangeNN, and T2TransitionFunctionNN for all the access terminals (356). When the RAN receives an updated ProfilelD from an access terminal (indicating the number of end users using that access terminal), it reconfigures the BucketLevelMaxNN, T2lnFlowRangeNN, and T2TransitionFunctionNN attributes for that access terminal based on the number of end users currently using the access terminals (358).

Because the use of the ProfilelD field to convey application specific information and using the BucketLevelMaxNN, T2lnFlowRangeNN, and T2TransitionFunctionNN attributes to control the reverse link is a standard part of the 1xEv-DO specification, this approach does not require any non-standard implementations in the access terminals or in any part of the RAN.

Although the techniques described above employ the 1xEV-DO air interface standard, the techniques are also applicable to other CDMA and non-CDMA air interface technologies in which allocating network resources based on the number of users of an access terminal is enabled.

The techniques described above can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal harddisks or removable disks; magneto-optical disks; and CD-ROM and DVD-ROM disks. The processor and the memory can be supplemented by, or incorporated in special purpose logic circuitry.

Although the techniques described above employ the 1xEV-DO air interface standard, the techniques are also applicable to other CDMA and non-CDMA air interface technologies in which QoS signaling is used to identify the number of users using an access terminal.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The techniques described herein can be performed in a different order and still achieve desirable results.

What is claimed is:

1. A method comprising
at a radio network controller, allocating a share of network resources to an access terminal that may be used by more than one user, the share being based on a parameter received from the access terminal and identifying a number of users using the access terminal.

2. The method of claim 1 in which the parameter identifies a range.

3. The method of claim 1 in which the parameter comprises a pre-defined value of a configuration parameter of a communication protocol.

4. The method of claim 3 in which the communication, protocol comprises an Ev-DO protocol and the configuration parameter comprises the ProfilelD.

5. The method of claim 1 in which allocating a share of network resources comprises determining a Grade of Service (GoS) appropriate to the number of users of the access terminal.

6. The method of claim 1 also comprising communicating information describing the allocated share of network resources to a radio node in communication with the access terminal.

7. The method of claim 1 also comprising
updating the share of network resources based on a new value of the parameter received from the access terminal.

8. The method of claim 1 in which allocating a share of network resources comprises
determining an amount of data that should be transmitted from the access terminal in a reverse link, based on the number of users of the access terminal, and
communicating an attribute representing the determined amount of data to the access terminal.

9. The method of claim 8 in which the parameter comprises a pre-defined value of a configuration parameter of an Ev-DO protocol,
the configuration parameter includes one or more of BucketLevelMaxNN, T2lnFlowRangeNN, and T2TransitionFunctionNN, and in which
communicating the attribute to the access terminal comprises using Generic Attribute Update Protocol (GAUP) to reconfigure the access terminal's reverse traffic channel media access controller (RTCMAC).

10. The method of claim 1 also comprising
allocating other shares of network resources to other access terminals based on values of the parameter received from the other access terminals.

11. A method comprising
at a radio network controller,
allocating shares of network resources between access terminals based on a parameter received from each of the access terminals identifying a number of users using each of the access terminals.

12. The method of claim 11 in which allocating shares of network resources comprises allocating a share of network resources to each access terminal based on the number of users of that access terminal as compared to the number of users of all the access terminals.

13. The method of claim 11 in which allocating shares of network resources comprises allocating a share of network resources to each access terminal based on a targeted quality of service to each user.

14. A method comprising
at an access terminal,
establishing communication with a first user,
transmitting a parameter to a radio area network,
establishing communication with an additional user, and
transmitting a second parameter to the radio area network.

15. The method of claim 14 in which transmitting the parameter comprises selecting the parameter from a set of parameters corresponding to numbers of users.

16. The method of claim 14 in which the parameter comprises a pre-defined value of a configuration parameter of a communication protocol.

17. The method of claim 16 in which the communication protocol comprises an Ev-DO protocol and the configuration parameter comprises the ProfilelD.

18. A system comprising
a radio network controller,
a radio node, and
a plurality of access terminals in communication with the radio node and the radio network controller,
in which each access terminal is configured to communicate to the radio network controller a parameter identifying a number of users of the access terminal, and
the radio network controller is configured to allocate shares of network resources among the access terminals based on the number of users of the access terminals, and to communicate information describing the allocation to the radio node.

19. An apparatus comprising
a radio network controller configured to allocate a share of network resources to an access terminal that may be used by more than one user, the share being based on a parameter received from the access terminal and identifying a number of users using the access terminal.

20. The apparatus of claim 19 in which the parameter identifies a range.

21. The apparatus of claim 19 in which the parameter comprises a pre-defined value of a configuration parameter of a communication protocol.

22. The apparatus of claim 21 in which the communication protocol comprises an Ev-DO protocol and the configuration parameter comprises the ProfilelD.

23. The apparatus of claim 19 in which the radio network controller is -configured to allocate a share of network resources by determining a Grade of Service (GoS) appropriate to the number of users of the access terminal.

24. The apparatus of claim 19 in which the radio network controller is also configured to communicate information describing the allocated share of network resources to a radio node in communication with the access terminal.

25. The apparatus of claim 19 in which the radio network controller is also configured to
update the share of network resources based on a new value of the parameter received from the access terminal.

26. The apparatus of claim 19 in which the radio network controller is configured to allocate a share of network resources by
determining an amount of data that should be transmitted from the access terminal in a reverse link, based on the number of users of the access terminal, and
communicating an attribute representing the determined amount of data to the access terminal.

27. The apparatus of claim 26 in which the parameter comprises a pre-defined value of a configuration parameter of an Ev-DO protocol,
the configuration parameter includes one or more of BucketLevelMaxNN, T2lnFlowRangeNN, and T2TransitionFunctionNN, and in which
the radio network controller is configured to communicate the attribute to the access terminal by using Generic Attribute Update Protocol (GAUP) to reconfigure the access terminal's reverse traffic channel media access controller (RTCMAC).

28. The apparatus of claim 19 in which the radio network controller is also configured to allocate other shares of network resources to other access terminals based on values of the parameter received from the other access terminals.

29. An apparatus comprising
a radio network controller configured to
allocate shares of network resources between access terminals based on a parameter received from each of the access terminals identifying a number of users using each of the access terminals.

30. The apparatus of claim 29 in which the radio network controller is configured to allocate shares of network resources by allocating a share of network resources to each access terminal based on the number of users of that access terminal as compared to the number of users of all the access terminals.

31. The apparatus of claim 29 in which the radio network controller is configured to allocate shares of network resources by allocating a share of network resources to each access terminal based on a targeted quality of service to each user.

32. An apparatus comprising
an access terminal configured to
establish communication with a first user,
transmit a parameter to a radio area network,
establish communication with an additional user, and
transmit a second parameter to the radio area network.

33. The apparatus of claim 32 in which the access terminal is configured to transmit the parameter by selecting the parameter from a set of parameters corresponding to numbers of users.

34. The apparatus of claim 32 in which the parameter comprises a pre-defined value of a configuration parameter of a communication protocol.

35. The apparatus of claim 34 in which the communication protocol comprises an Ev-DO protocol and the configuration parameter comprises the ProfilelD.

36. A medium bearing instructions to cause a radio network controller to
allocate a share of network resources to an access terminal that may be used by more than one user, the share being based on a parameter received from the access terminal and identifying a number of users using the access terminal.

37. The medium of claim 36 in which the parameter identifies a range.

38. The medium of claim 36 in which the parameter comprises a pre-defined value of a configuration parameter of a communication protocol.

39. The medium of claim 38 in which the communication protocol comprises an Ev-DO protocol and the configuration parameter comprises the ProfilelD.

40. The medium of claim 36 in which the instructions cause the radio network controller to allocate a share of network resources by determining a Grade of Service (GoS) appropriate to the number of users of the access terminal.

41. The medium of claim 36 in which the instructions also cause the radio access network to communicate information describing the allocated share of network resources to a radio node in communication with the access terminal.

42. The medium of claim 36 in which the instructions also cause the radio access network to update the share of network resources based on a new value of the parameter received from the access terminal.

43. The medium of claim 36 in which the instructions cause the radio network controller to allocate a share of network resources by
determining an amount of data that should be transmitted from the access terminal in a reverse link, based on the number of users of the access terminal, and
communicating an attribute representing the determined amount of data to the access terminal.

44. The medium of claim 43 in which the parameter comprises a pre-defined value of a configuration parameter of an Ev-DO protocol,
the configuration parameter includes one or more of BucketLevelMaxNN, T2lnFlowRangeNN, and T2TransitionFunctionNN, and in which
the instructions also cause the radio network controller to communicate the attribute to the access terminal by using Generic Attribute Update Protocol (GAUP) to reconfigure the access terminal's reverse traffic channel media access controller (RTCMAC).

45. The medium of claim 36 in which the instructions also cause the radio access network to
allocate other shares of network resources to other access terminals based on values of the parameter received from the other access terminals.

46. A medium bearing instructions to cause a radio network controller to
allocate shares of network resources between access terminals based on a parameter received from each of the access terminals identifying a number of users using each of the access terminals.

47. The medium of claim 46 in which the instructions cause the radio network controller to allocate shares of network resources by allocating a share of network resources to each access terminal based on the number of users of that access terminal as compared to the number of users of all the access terminals.

48. The medium of claim 46 in which instructions cause the radio network controller to allocate shares of network resources by allocating a share of network resources to each access terminal based on a targeted quality of service to each user.

49. A medium bearing instructions to cause a an access terminal to
establish communication with a first user,
transmit a parameter to a radio area network,
establish communication with an additional user, and
transmit a second parameter to the radio area network.

50. The medium of claim 49 in which instructions cause the access terminal to transmit the parameter by selecting the parameter from a set of parameters corresponding to numbers of users.

51. The medium of claim 49 in which the parameter comprises a pre-defined value of a configuration parameter of a communication protocol.

52. The medium of claim 51 in which the communication protocol comprises an Ev-DO protocol and the configuration parameter comprises the ProfilelD.
